(19) United States
(12) Patent Application Publication
(10) Pub. No.: US 2007/0050472 A1
(43) Pub. Date: Mar. 1, 2007

(54) Device and method for requesting and providing content information over network

(75) Inventor: Soon-back Cha, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/506,895

(22) Filed: Aug. 21, 2006

(30) Foreign Application Priority Data
Aug. 25, 2005 (KR) 10-2005-0078321

(51) Int. Cl. G06F 15/16

(52) U.S. Cl. 709/217

(57) ABSTRACT

A device and method for are provided requesting and providing content information over a network, in which content information stored in network devices on the network can be rapidly provided by transmitting a search request packet, in which predetermined search conditions are set, to the network devices in a multicast manner. The device includes a search request unit which generates a search request packet to request an information search for content from devices existing on the network; a transmitting unit which transmits the constructed search request packet to the devices existing on the network in a multicast manner; and a result collection unit which collects and manages content information received from the devices that received the search request packet.

### CROSS-REFERENCE TO RELATED APPLICATION

This application claims priority from Korean Patent Application No. 10-2005-0078321 filed on Aug. 25, 2005 in the Korean Intellectual Property Office, the disclosure of which is incorporated herein by reference in its entirety.

### BACKGROUND OF THE INVENTION

1. Field of the Invention

Apparatuses and methods consistent with the present invention relate to requesting and providing content information over a network and, more particularly, to requesting and providing content information over a network, in which content information stored in network devices on the network can be rapidly provided by transmitting a search request packet, in which predetermined search conditions are set, to the network devices in a multicast manner.

2. Description of the Related Art

There are three types of Internet Protocol (IP) addressing methods: unicast, broadcast and multicast. In a host located in a shared type network such as an Ethernet network, each Ethernet frame includes source and destination Ethernet addresses. In general, each Ethernet frame is transmitted toward one host and a destination address specifies one interface.

Communication between a single transmitter and a single receiver is unicast. Ping, Telnet, FTP and WWW correspond to unicast.

Meanwhile, a frame can be transmitted from a predetermined host to all of the other hosts on a network. This is called broadcast.

The broadcast transmission method is a method of transmitting only one piece of data to a number of clients. This method is efficient in terms of line use in comparison with the unicast method, but does not transfer data reliably.

As an intermediate concept between unicast and broadcast, each frame can be transmitted to a specific group on the network. This method is called multicast.

Multicast is a method of efficiently transmitting consecutive data in a one-to-many or many-to-many manner using one multicast group address.

In this case, one of the problems existing in the broadcast method is that hosts not related to the broadcast must also process frames.

However, in the multicast method, data generated from a source is copied once, and routed and then transmitted to a client. Therefore, there is no case where an unnecessary packet is transferred to some other network, such as in a bridge.

A purpose of multicast is to reduce the load on hosts that has no connection with the broadcast. In a multicast manner of transmission, a host belongs to one or more multicast groups.

FIG. 1 is a conceptual view illustrating IP communication according to the related art.

The header of a data packet that is transmitted from a transmitting side to a receiving side must contain the IP address of the transmitting side, the IP address of the receiving side, and a port number based on a transmission method.

The data packet can be transmitted to the receiving side through a corresponding routing path. The receiving side may make a response confirming that the data packet has been received to the transmitting side according to the communication protocol.

In a client-server network configuration, when a client desires to receive data from the server, the client must know the IP information of a server.

Furthermore, if the server has a dynamic IP address, the address of the server, which is indicated in the header of a transmission data packet, must be corrected and transmitted whenever the address is changed.

Meanwhile, when information about content is requested over a network on which a number of devices exist, all of the devices currently gaining access to the network must be sequentially requested to search for the corresponding content. Therefore, a problem arises in that a lot of time is taken to obtain the desired content information.

Furthermore, the time taken to search for content information according to the request for a content search varies with every device. Therefore, there is a problem in that a device that has requested a content search must wait to receive search results for an unspecified time period.

In view of the above problems, there is a need for an alternative technology of reducing search requesting time by requesting a number of devices on the network to search for content information according to the multicast method, and predicting the time in which search results will be received by setting content search time.

Korean Unexamined Patent Publication No. 2003-050905 (entitled “Home Network Communication Method using Network Address Translation Function) discloses a home network communication method using a network address translation function, in which IP addresses of data packets received from an Internet communication network are translated into internal home network addresses, the translated addresses are transmitted to respective computer terminals in a multicast manner, and each of the computer terminals selectively receives only a data packet that it has requested. However, this method does not disclose a technology of constructing a search request packet for predetermined content, transmitting the constructed search request packet in a multicast manner and searching for content based on the search conditions defined in the search request packet.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a device and method in which content information stored in network devices on a network can be rapidly provided by transmitting a search request packet to the network devices in a multicast manner.

The present invention also provides a devices and method in which a network device that has transmitted a search request packet can be rapidly provided with desired content by searching for content information based on the search request packet that contains predetermined search conditions (that is, information to be searched for, the required search time, information about the destination to which search results are to be transmitted, and others).

According to an aspect of the present invention, there is provided a device for requesting and providing content information over a network, including a search request unit constructing a search request packet to request an information search for content from devices existing on the network; a transmitting unit transmitting the constructed search request packet to the devices existing on the network in a multicast manner; and a result collection unit collecting and managing content information received from the devices that have received the search request packet.

According to another aspect of the present invention, there is provided a device for requesting and providing content information over a network, including a search processing unit searching its content information according to a search request packet transmitted from a specific device existing on the network; and a transmitting unit transmitting found content information in a unicast manner.

According to an aspect of the present invention, there is provided a method of requesting and providing content information over a network, including constructing a search request packet to request an information search for content from devices existing on the network; transmitting the constructed search request packet to the devices existing on the network in a multicast manner; and collecting content information from the devices that have received the search request packet.

According to another aspect of the present invention, there is provided a method of requesting and providing content information over a network, including receiving a search request packet from a device existing on the network; searching content information based on the received search request packet; and transmitting found content information in a unicast manner.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a conceptual view illustrating IP communication according to the related art;

FIG. 2 is a diagram illustrating a network system in which devices that request and provide content information operate on a network, according to an exemplary embodiment of the present invention;

FIGS. 3A to 3D are diagrams illustrating the format of a search request packet that is multicast by the devices that request and provide content information on the network according to an exemplary embodiment of the present invention;

FIG. 4 is a block diagram illustrating a device that requests or provides content information over a network according to an exemplary embodiment of the present invention; and

FIG. 5 is a flowchart illustrating a method of requesting and providing content information on a network according to an exemplary embodiment of the present invention.

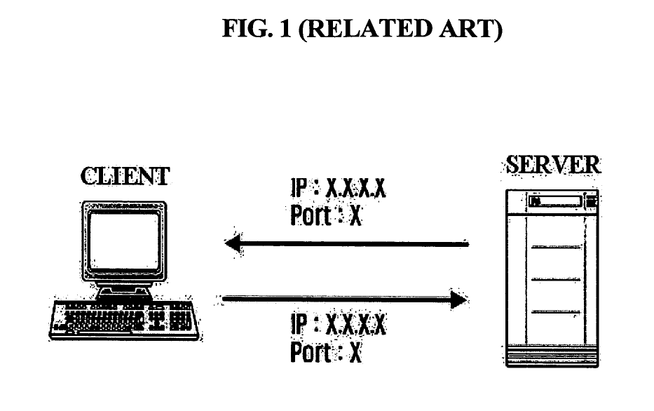

### DESCRIPTION OF THE EXEMPLARY, EMBODIMENTS OF THE INVENTION

Reference now should be made to the drawings, in which the same reference numerals are used throughout the different drawings to designate the same or similar components.

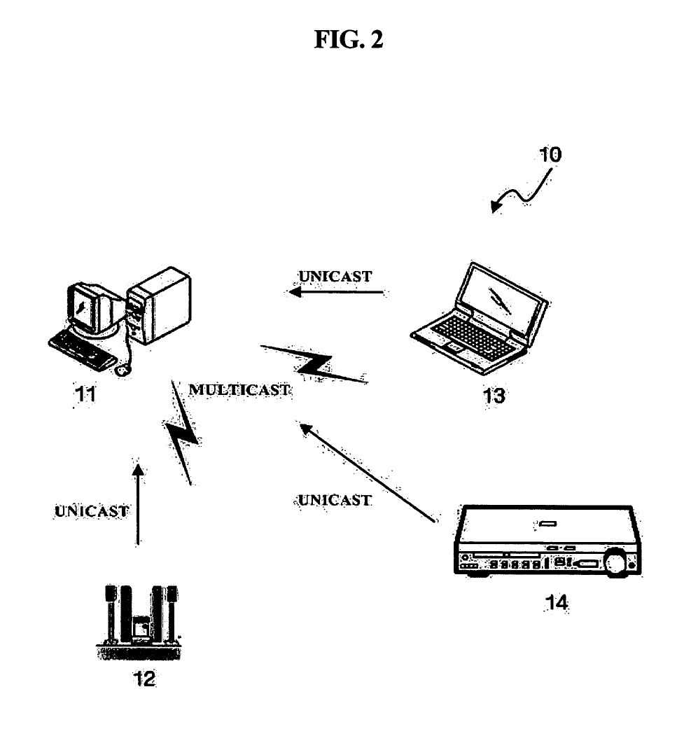

FIG. 2 is a diagram illustrating a network system in which devices that request and provide content information operate on a network, according to an exemplary embodiment of the present invention.

As illustrated in FIG. 2, a number of network devices 11, 12, 13, and 14 (collectively, network devices 10) exist on a network. The network devices 10 are hosts and devices that use Transmission Control Protocol/Internet Protocol (TCP/IP) and store content files and metadata for the content files. For example, the network devices 10 may be desktop computers, notebook computers, home theater systems, personal video recorders (PVRs), or the like.

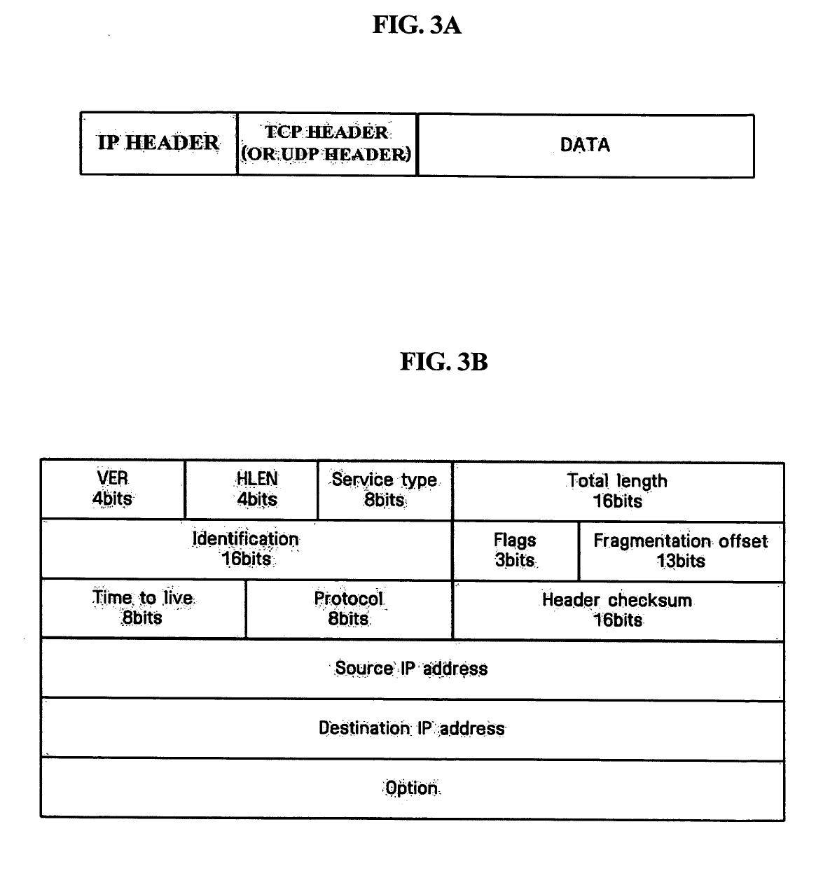

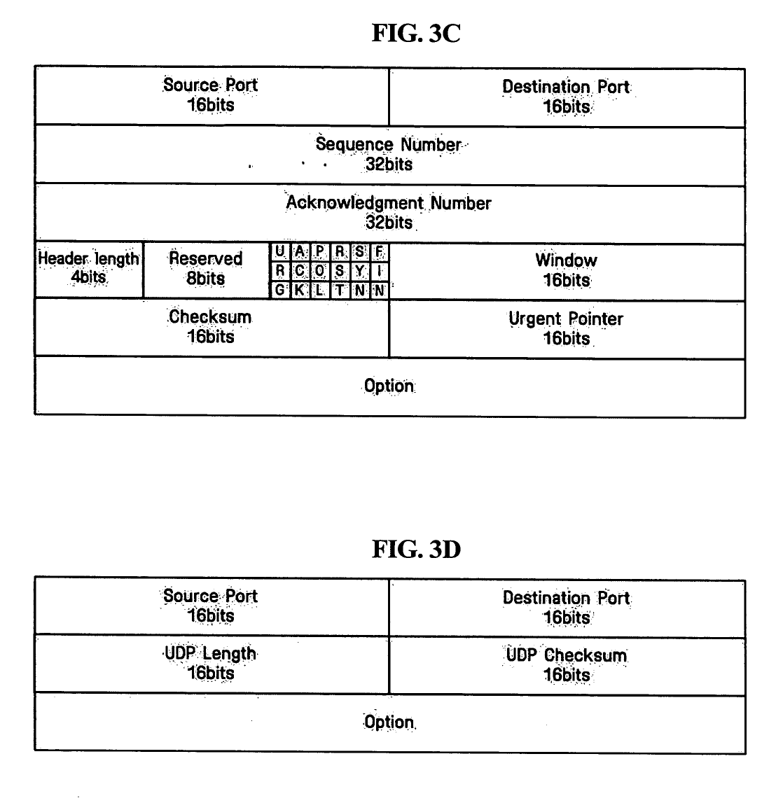

The first network device 11 constructs a search request packet and transmits the constructed packet to the other network devices 12, 13 and 14 in a multicast manner in order to request them to search for specific content. In this case, the search request packet contains search conditions for the specific content, such as information to be searched for, the required search time, the number of top search results and information about the destination to which search results are to be transmitted. The format of the search request packet will be described in detail later with reference to FIG. 3.

Thereafter, the network devices 12, 13 and 14 that have received the search request packet from the first network device 11 examine the search request packet and search their content according to the search conditions set by the first network device 11.

For example, if, as a result of the examination, the information to be searched for is an actor, a director, and a genre (for example, actor: Tom Cruise, director: Steven Spielberg, and genre: action), the required search time is 2 minutes, the number of top search results is 1 and the search result transmission destination, that is, the IP port, is 000.000.000.000: 00000, the network devices 12, 13 and 14 search metadata for the content stored in their storage units according to the search conditions.

The network devices 12, 13 and 14 then unicast the found content information to the address of the search result transmission destination (that is, the IP of the first network: port).

Therefore, the first network device 11 can rapidly receive information about desired content.

FIGS. 3A to 3D are diagrams illustrating the format of a search request packet that is multicast by the devices that request and provide content information on the network according to an exemplary embodiment of the present invention.

As illustrated in FIG. 3A, the search request packet includes an IP header, a TCP (or User Datagram Protocol (UDP)) header, and a data part.

The IP header includes the address of the network device that transmits the search request packet and the address of the network device that will receive the search request packet. Furthermore, the TCP header includes the port number of the network device that transmits the search request packet, the port number of the network device that will receive the search request packet, and information for reliable communication.

The UDP header includes the port number of the network device that transmits the search request packet and the port number of the network device that will receive the search request packet.

Furthermore, the data part includes search conditions for content, such as information to be searched for, the required search time, the number of top search results, information about the destination to which search results are to be transmitted, and the like.

In the present invention, search results can be provided through a TCP port using a TCP header, or can be provided through a UDP port using a UDP header.

FIG. 3B illustrates the format of the IP header. As illustrated in FIG. 3B, a version (VER) field contains an IP version number, and a header length (HLEN) field designates the length of the IP header. Furthermore, a service type field contains an input regarding an IP protocol device for processing a message according to fixed rules. A total length field contains the length of the packet, including the protocol header. Furthermore, an identification field is a unique identifier generated by a transmission host and is used to identify the connection segments of fragments at the time of recombining the fragments. In a flags field, two bits, including a DF (Don't Fragment) bit and an MF (More Fragment) bit, are used to control the processing of a packet in the case of fragmentation. A fragmentation offset field refers to the location of a sub message, which is included in a packet, relative to the start of the entire message in the case where the MF bit is set. Furthermore, a time to live field refers to a maximum number of nodes through which a packet can pass. A transport protocol field contains a transport protocol ID to which a packet must be transmitted. A header checksum field has a checksum for the protocol header. Furthermore, source and destination address fields include the address of the network device that transmits the search request packet and the address of the network device that will receive the search request packet. In addition, an option field includes additional items that will be examined after the examination of the IP protocol header for the purpose of special tasks.

Therefore, according to the exemplary embodiment, the source and destination address fields are transmitted in a multicast manner and contain the address of the network device that transmits a search request packet and the address of a network device that will receive the search request packet.

FIG. 3C illustrates the format of the TCP header. As illustrated in FIG. 3C, in a source port field, the port number of a network device that transmits a search request packet is set. In a destination port field, the port number of a network device that will receive a search request packet is set. A sequence number field is a sequence number indicating the unit of a data stream that will be transmitted by the network device that transmits the search request packet. Furthermore, an acknowledgement number field contains a transmission sequence number that should be transmitted by a counterpart at the time of next receipt. In addition, a header length field designates the length of a TCP header. A reserved field is a field that is reserved for future extension.

Furthermore, a code bit field is also called a control flag or a control bit, and has six types of control values. If “1” is designated, it has the following meaning. A URG (Urgent Flag) means that there is data that should be urgently processed. An ACK (Acknowledgement Flag) uses a response acknowledgement number. A PSH (Push Flag) indicates that data received via TCP is transmitted to an upper application. Furthermore, an RST (Reset Flag) means that a TCP virtual line is bilaterally disconnected when a packet is retransmitted but communication is not recovered. A SYN (Synchronize Flag) is used at the time of establishing a virtual circuit and initializes a sequence number to the transmission sequence number shown in the TCP header. An FIN (Fin Flag) indicates that data that is transmitted by the network device having transmitted the search request packet terminates. In this case, reception remains possible. In the case of normal termination, a side that first requests the termination provides notification of the termination request using a TCP header that specifies the FIN, and a receiving side performs a termination process and returns the TCP header that specifies the FIN, thus completing the entire process.

Furthermore, a window field indicates the degree of data to be received from a SEQ number shown in the ACK field. With regard to a checksum field, the network device that has transmitted a search request packet constructs a pseudo TCP header, calculates a checksum and transmits the checksum included in the checksum field. The network device that receives the search request packet constructs a pseudo header identical to the pseudo header constructed by the device that has transmitted the search request packet, calculates a checksum, and examines whether data has been normally received.

An urgent pointer field is treated as a pointer that points to data that should be urgently processed. The urgent pointer indicates the number of bytes to be processed. The processing starts from the front of the data added behind the TCP head (indicating a transmission sequence number). An option field is used to control details of communication, and is seldom used. The total length of the option field must be determined to be a multiple of 32 bits.

Therefore, in the exemplary embodiment, a search request packet is transmitted in a multicast manner, with the port number of the network device that transmits the search request packet being set in the source port field thereof.

FIG. 3D illustrates the format of the UDP header. As illustrated in FIG. 3D, in a source port field, the port number of the network device that transmits a search request packet is set. The port number of the network device that transmits the search request packet is an optional value that may not be specified. In this case, “0” indicates that a port number is not specified. This is used when communication not requiring a response is performed. In a destination port field, the port number of the network device that will receive a search request packet is set. In a UDP length field, the sum of a UDP header length and a user data length is set on a byte basis. A UDP checksum field is used to increase reliability in communication.

Therefore, in the exemplary embodiment, a search request packet is transmitted in a multicast manner, with the port number of the network device that transmits the search request packet being set in the source port field.

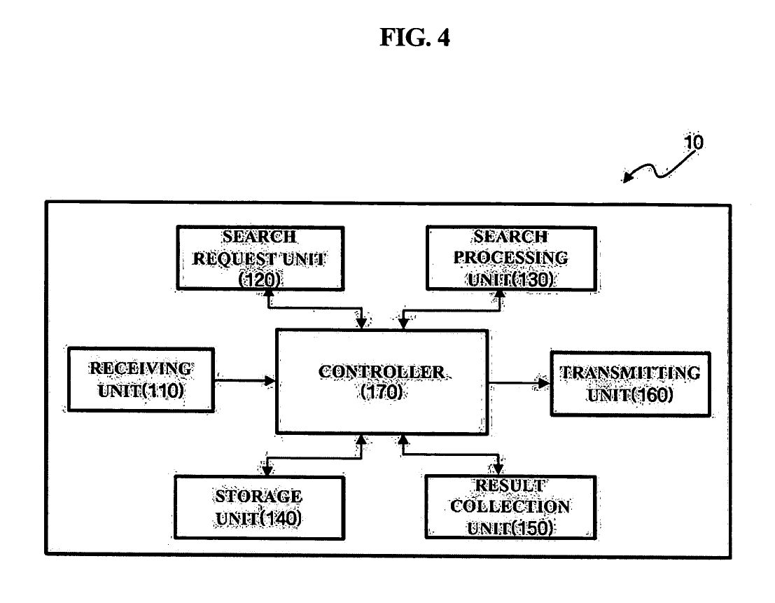

FIG. 4 is a block diagram illustrating a device that requests or provides content information over a network according to an exemplary embodiment of the present invention.

As illustrated in FIG. 4, each of the network devices 10 includes a receiving unit 110, a search request unit 120, a search processing unit 130, a storage unit 140, a result collection unit 150, a transmitting unit 160, and a controller 170. Each network device 10 can serve as both a server that requests content information from network devices on a network, and a client that receives a request for a search for content information from a predetermined network device and searches its content information.

The term “unit”, as used herein, means, but is not limited to, a software or hardware component, such as a Field Programmable Gate Array (FPGA) or an Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables (a unit is not limited to these examples). The functionality provided for in the components and units may be combined into fewer components and units or further separated into additional components and units. Furthermore, the components and units may be implemented to drive one or more CPUs of a device or a security multimedia card.

The network device 11 that serves as a server that requests content information from network devices on a network for the exemplary embodiment will be first described. As previously noted, any of the network devices 10 of the exemplary embodiment may serve as a server.

The search request unit 120 constructs a search request packet to request an information search for predetermined content from devices on the network. The search request packet includes information to be searched for, the required search time, the number of top search results, information about the destination to which search results are to be transmitted, and the like.

In this case, the required search time is used to implement a process in which a predetermined time, during which content depending on information to be searched for will be searched, is allocated, the search is stopped after the allocated time has elapsed, and the results which are found are transmitted. The setting of the required search time serves to solve the problem in which one device must wait for an unspecified time period in order to receive search results from a predetermined network device. Furthermore, the setting of the number of the top search results is used to reduce the time taken for a corresponding network device to search for predetermined content. Furthermore, the provision of information about the destination to which search results are to be transmitted allows content information stored in respective network devices to be shared on the network in such a manner that a search request packet is transmitted in a multicast manner and the network devices that have received the search request packet transmit search results to set a destination address in a unicast manner.

For example, the information to be searched for is detailed information about specific content to be searched for, and may be an actor, a director, a movie title and a genre in the case of a search for movie content. The required search time refers to the time required to search content information depending on corresponding information to be searched for. The number of top search results refers to the amount of information about content that will be found according to the search conditions. For example, when the number of top search results is set to 10, only ten pieces of information about content found by the search are to be transmitted. The destination information refers to the address to which searched results are to be transmitted. A destination address is set as the destination information, so that network devices can share content information.

The transmitting unit 160 transmits the constructed search request packet, which has been received from the search request unit 120, to devices on the network in a multicast manner.

The receiving unit 110 receives search results that have been transmitted in a unicast manner by the devices that have received the search request packet.

The result collection unit 150 functions to collect and manage content information received by the receiving unit 110. The result collection unit 150 collects search results output from a number of network devices for a predetermined time period and then transmits the collected search results (that is, content information) to the controller 170.

The controller 170 functions to control the overall operation of the network device and causes a search request packet, which is constructed by the search request unit 120, to be multicast through the transmitting unit 160. The controller 170 also provides a user with the search results collected through the result collection unit 150.

The network device 12, 13 or 14, serving as a client that receives a request for a search for content information from a specific network device and searches its content information, are described below. As stated above, any of the exemplary network devices 10 may serve as a client.

The receiving unit 110 receives a search request packet that has been transmitted in a multicast manner from a specific device existing on the network.

The search processing unit 130 searches its content information for corresponding content based on the search request packet received by the receiving unit 110.

For example, when the search request packet is received, the search processing unit 130 examines the search request packet to determine the search conditions. The search conditions included in the search request packet can include information to be searched for, the required search time, the number of top search results, and information about the destination to which search results are to be transmitted.

The search processing unit 130 then searches its own content according to the received search conditions and transmits the results found by the search to the controller 170.

For example, if the number of found content information is larger than the number of top search results set in the search conditions when the search processing unit 130 searches for predetermined content according to the search conditions, the search processing unit 130 transmits only a number of search results corresponding to the number of the top search results that is set on the basis of a searched sequence.

The storage unit 140 stores content files and metadata for the content file.

The transmitting unit 160 transmits in a unicast manner content information found through the search processing unit 130 to set destination information (that is, a set address).

When the search request packet is received from the receiving unit 110, the controller 170 transmits the received search request packet to the search processing unit 130 and controls the search processing unit 130 to search for content information according to the search conditions.

Furthermore, the controller 170 controls the transmitting unit 160 so that the content information found by the search processing unit 130 can be transmitted to a preset destination address.

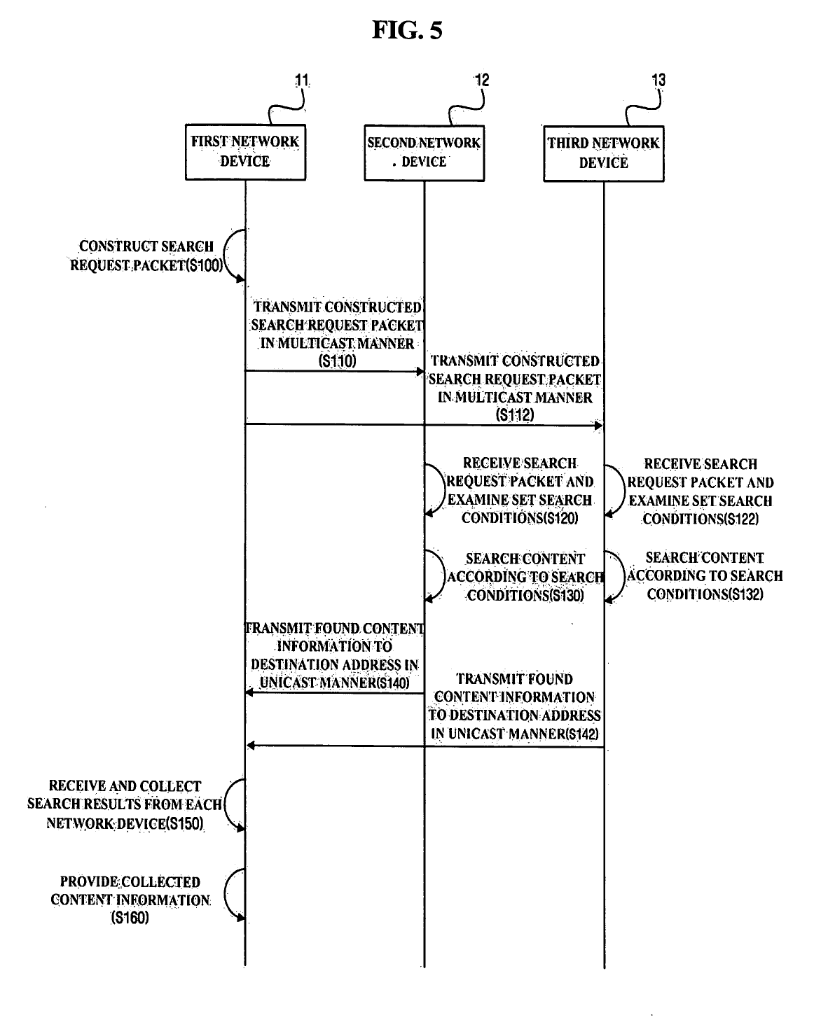

FIG. 5 is a flowchart illustrating a method of requesting and providing content information over a network according to an exemplary embodiment of the present invention. In this case, it is assumed that the first network device 11, the second network device 12, and the third network device 13 exist on the network, and the first network device 11 requests content information from the second network device 12 and the third network device 13.

As illustrated in FIG. 5, the search request unit 120 of the first network device 11 constructs a search request packet for predetermined content in operation S100. In this case, the search request packet may include information to be searched for, the required search time, the number of top search results, and information about the destination to which search results are to be transmitted.

For example, a search request packet, in which the information to be searched for is set to “Tom Cruise”, “Steven Spielberg” and “action genre”, the required search time is set to 2 minutes, the number of top search results is set to 5, and the search results destination information (IP port) is set to 192.168.23.100: 1202, may be constructed.

Thereafter, the controller 170 directs the transmitting unit 160 to transmit the constructed search request packet to the second network device 12 and the third network device 13 in a multicast manner in operations S110 and S112.

The receiving units 110 of the second network device 12 and the third network device 13 receive the search request packet from the first network device 11 and transmit the received search request packet to the search processing units 130 thereof in operations S120 and S122.

The search processing unit 130 examines the received search request packet to determine the search conditions, and searches content information stored in the storage unit 140 based on the checked search conditions in operations S130 and S132.

For example, the search processing unit 130 can search for a content file regarding “Tom Cruise”, “Steven Spielberg” and “action genre” using the meta-information of its content files. In this example, the search can be performed for 2 minutes, and only five search results can be selected according to the found sequence. In this case, the found content may be content that satisfies the information to be searched for (for example, Tom Cruise, Steven Spielberg and action genre) or may be content that satisfies any one of the pieces of information to be searched for.

Thereafter, the controller 170 directs the transmitting unit 160 to transmit content information found by the search processing unit 130 to a preset destination address (for example, 192.168.23.100: 1202) in a unicast manner in operations S140 and S142.

Thereafter, the receiving unit 110 of the first network device 11 receives the search results (that is, content information) transmitted in a unicast manner by the second network device 12 and the third network device 13, and the result collection unit 150 collects the received search results for a predetermined time in operation S150. In this case, the predetermined time may be the time in which the search results are all received from a number of network devices.

Thereafter, the result collection unit 150 transmits the collected search results to the controller 170, and the controller 170 provides a user with the search results received from the result collection unit 150 in operation S160.

As described above, when any one of the network devices existing on the network wants to receive desired content information, the network device constructs a search request packet and transmits the constructed search request packet in a multicast manner to a number of network devices on the network. The network devices that have received the search request packet search content information according to search conditions included in the search request packet and transmit searches results to the network device that has transmitted the search request packet in a unicast manner. As a result, a network device that has requested the search for the predetermined content can be rapidly provided with desired search results.

As described above, the device and method for requesting and providing content information over a network according to the exemplary embodiments of the present invention may have one or more of the following aspects.

A search request packet is transmitted to network devices on the network in a multicast manner. Therefore, a number of network devices can receive a search request packet at the same time and search for content information. Therefore, the desired content information can be rapidly provided.

Furthermore, content information is searched for based on a search request packet including predetermined search requirements (that is, information to be searched, the required search time, information about a destination to which search results are to be transmitted and/or the like). Therefore, search results appropriate for a network device that transmits a search request packet can be obtained.

Furthermore, the required search time is set in search conditions. Therefore, searched results are transmitted as soon as the required search time elapses. Therefore, desired information can be rapidly provided.

Furthermore, a search request packet is transmitted to network devices existing on the network in a multicast manner. Therefore, the network load can be reduced.

Although exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for requesting and providing content information over a network, the device comprising:
a search request unit which generates a search request packet to request an information search for content from devices existing on the network;
a transmitting unit which transmits the search request packet to the devices existing on the network in a multicast manner; and
a result collection unit which collects content information received from the devices that received the search request packet.

2. The device of claim 1, wherein the search request packet comprises information regarding the content to be searched for, an amount of time for the information search, and information about a destination to which search results are to be transmitted.

3. The device of claim 1, further comprising a receiving unit which receives the content information that are transmitted in a unicast manner by the devices that have received the search request packet.

4. A device for requesting and providing content information over a network, the device comprising:
a search processing unit which searches content information according to a search request packet received from a specific device existing on the network; and
a transmitting unit which transmits found content information in a unicast manner.

5. The device of claim 4, wherein the search request packet comprises information regarding the content information to be searched for, an amount of time for searching, and information about a destination to which the found content information are to be transmitted.

6. A method of requesting and providing content information over a network, the method comprising:
generating a search request packet to request an information search for content from devices existing on the network;
transmitting the search request packet to the devices existing on the network in a multicast manner; and
collecting content information from the devices that received the search request packet.

7. The method of claim 6, wherein the search request packet comprises information regarding the content to be searched for, an amount of time for the information search, and information about a destination to which search results are to be transmitted.

8. A method of requesting and providing content information over a network, the method comprising:
receiving a search request packet from a device existing on the network;
searching content information based on the received search request packet; and
transmitting found content information in a unicast manner.

9. The method of claim 8, wherein the search request packet comprises information regarding the content information to be searched for, an amount of time for the searching, and information about a destination to which search results are to be transmitted.

10. A network comprising:
a first network device; and
at least one second network device;
wherein the first network device generates a search request packet and transmits the search request packet to the at least one second network device; and
wherein the at least one second network device receives the search request packet, performs a search of content information based on the search request packet and transmits results of the search to the first network device.

11. The network according to claim 9, wherein there are a plurality of second network devices and the first network device transmits the search request packet in a multicast manner to the plurality of second network devices; and
wherein each of the plurality of second network devices transmits the results of the search to the first network device in a unicast manner.

12. The network according to claim 10, wherein the search request packet indicates the content information to be searched for, an amount of time for the search and information regarding a destination to which results of the search are to be transmitted.
